(19) United States
(12) Patent Application Publication
(10) Pub. No.: US 2017/0343426 A1
(43) Pub. Date: Nov. 30, 2017

(54) SENSOR UNIT, APPARATUS WITH SENSOR UNIT AND ASSEMBLING METHOD OF SENSOR UNIT

(71) Applicant: HONDA MOTOR CO., LTD., Tokyo (JP)

(72) Inventors: Toru HIRANISHI, Wako (JP); Yuta ITO, Wako (JP)

(73) Assignee: HONDA MOTOR CO., LTD., Tokyo (JP)

(21) Appl. No.: 15/609,018

(22) Filed: May 31, 2017

(30) Foreign Application Priority Data
May 31, 2016 (JP) 2016-108557

(51) Int. Cl. G01K 13/02; B60R 16/023; F01M 11/10

(52) U.S. Cl. CPC G01K 13/02; B60R 16/0234; F01M 2011/1473; G01K 2013/026; F16N 2250/08

(57) ABSTRACT

A sensor unit includes a sensor, a coupler, and a body. The coupler is connected to the sensor. The sensor is to be connected to an outside of the sensor unit via the coupler. The body supports the sensor and the coupler. The body is to be attached to an equipment from an outside of the equipment which includes an object to be detected by the sensor. The body includes an external appearance to distinguish the sensor unit from an another sensor unit which has an another sensor different from the sensor.

### CROSS-REFERENCE TO RELATED APPLICATIONS

The present application claims priority under 35 U.S.C. §119 to Japanese Patent Application No. 2016-108557, filed May 31, 2016. The contents of this application are incorporated herein by reference in their entirety.

### BACKGROUND

### 1. Field

The present invention relates to a sensor unit, an apparatus with the sensor unit and an assembling method of the sensor unit.

### 2. Description of the Related Art

Various sensors are used for a vehicle such as a motorcar and the like. For example, for a transmission of the motorcar there is used a sensor such as ATF, etc. for detecting an oil temperature. The sensor is a sensor unit which is provided with a sensor element and a coupler to which the wiring is connected, for example. In the sensor unit, there may be cases where a characteristic of the sensor element is changed by a technical improvement and the like. When the characteristic of the sensor is changed, the necessity for changing a content of control may be caused in response to the change of a medium value, a threshold, etc. for example. Since the content of the control and the characteristic of the sensor element are required to be matched, the sensor unit which has a specific sensor element in response to the control content is selected from a plurality of sensor units and assembled into the target equipment.

Since it is necessary to select the specific sensor unit from the plurality of sensor units which can be assembled into the equipment, the technique capable of preventing an incorrect sensor unit from being assembled is proposed (see Japanese Patent Application Laid-Open Publication No. 2009-154739 and Japanese Patent Application Laid-Open Publication No. H06-147754).

For example, in order to prevent the incorrect sensor unit from being assembled, it is effective that a coupler of the sensor unit to be used is formed in a different shape from a coupler of another sensor unit. When this configuration is employed, in the case where another sensor unit is assembled into the equipment by error, the wiring is not connected to that sensor unit, so that the equipment inviting the erroneous assembly of the sensor unit may be removed.

### SUMMARY

According to a first aspect of the present invention, a sensor unit includes a sensor element, a coupler, and a body. The coupler is connected to the sensor element . The body is configured to support the sensor element and the coupler and to be assembled from an outside into equipment which has a part to be detected. The body has an external appearance identification part capable of distinguishing the sensor unit from other sensor unit which has other sensor element different from the sensor element.

According to a second aspect of the present invention, a sensor unit includes a sensor, a coupler, and a body. The coupler is connected to the sensor. The sensor is to be connected to an outside of the sensor unit via the coupler. The body supports the sensor and the coupler. The body is to be attached to an equipment from an outside of the equipment which includes an object to be detected by the sensor. The body includes an external appearance to distinguish the sensor unit from an another sensor unit which has an another sensor different from the sensor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a plan view of a sensor unit in accordance with an embodiment of the present invention;

FIG. 2 is a cross sectional view taken along line I-I of the sensor unit as shown in FIG. 1;

FIG. 3 is a plan view of an external shape of the sensor unit as shown in FIG. 1;

FIG. 4 is a plan view of equipment with the sensor unit in which the sensor unit as shown in FIG. 1 is assembled into the equipment;

FIG. 5 is a plan view of an example of the sensor unit which has another sensor element;

FIG. 6 is a flow chart of a sensor unit assembling method in accordance with the embodiment of the present invention; and

FIG. 7 is a block diagram showing an example of a correctness determination device to be usable in the sensor unit assembling method in accordance with the embodiment of the present invention.

### DESCRIPTION OF THE EMBODIMENTS

The embodiments will now be described with reference to the accompanying drawings, wherein like reference numerals designate corresponding or identical elements throughout the various drawings. Hereunder, an embodiment of the present invention will be explained with reference to accompanying drawings.

### [Sensor Unit]

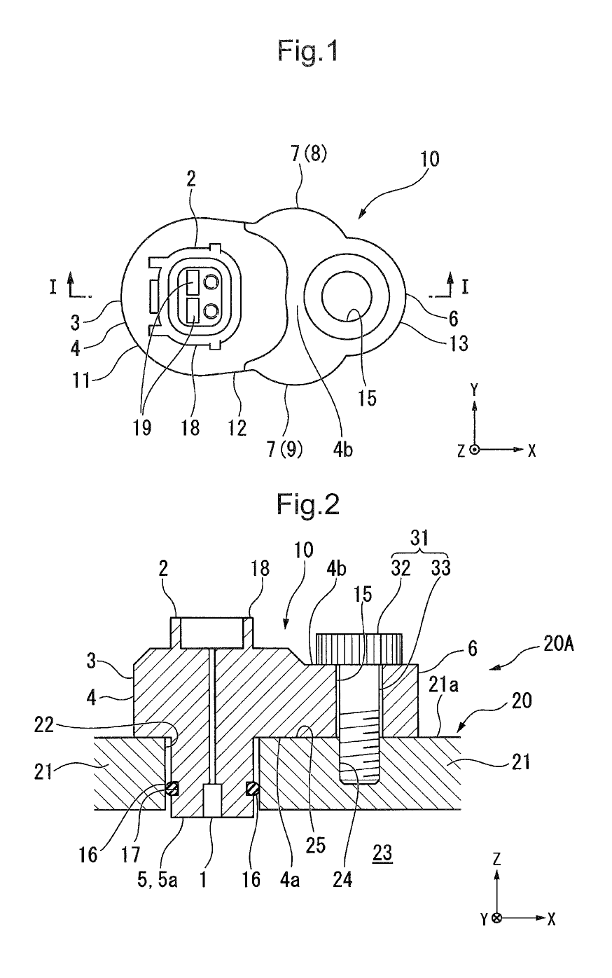

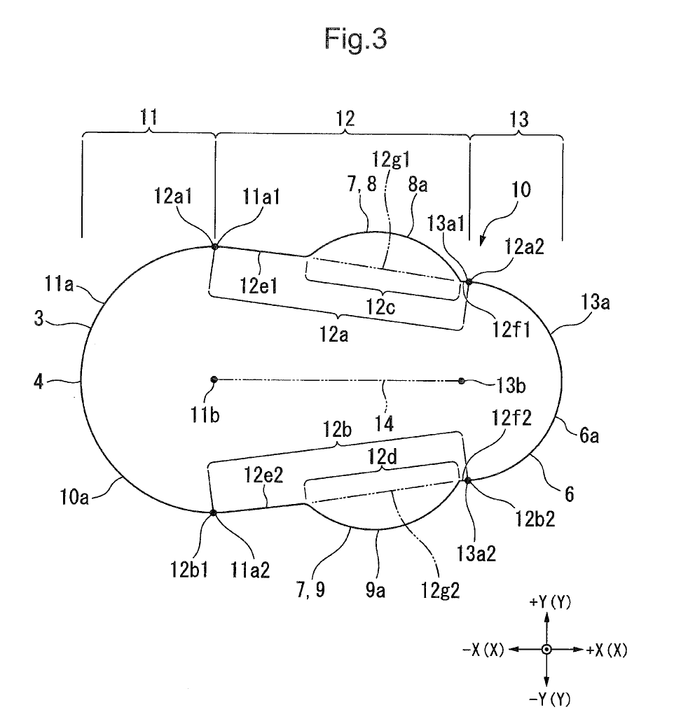

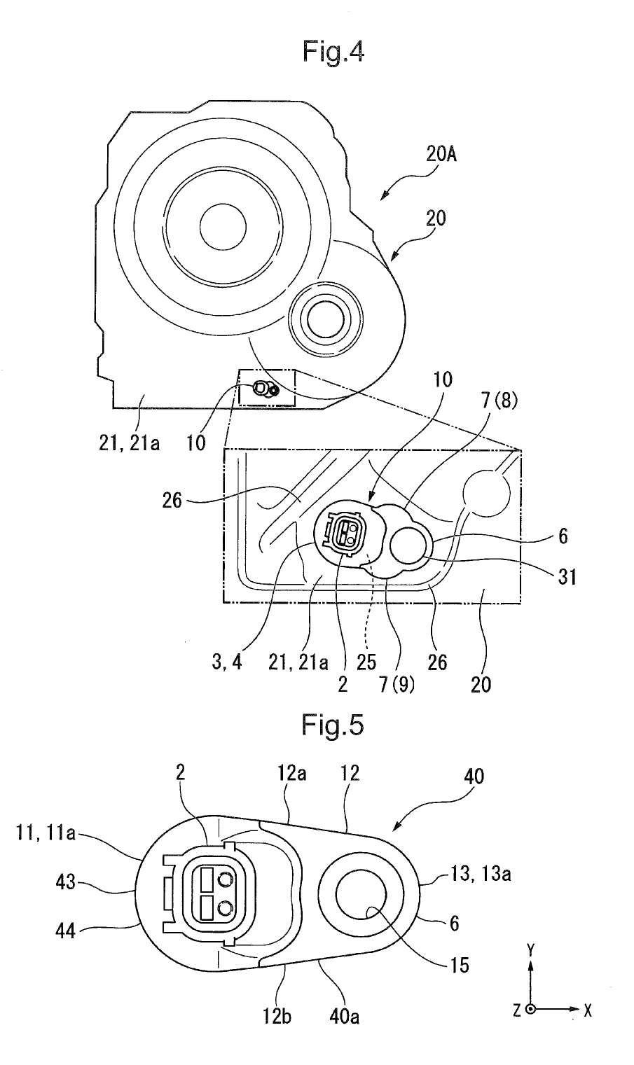

FIG. 1 is a plan view of a sensor unit 10 in accordance with an embodiment of the present invention. FIG. 2 is a cross sectional view of the sensor unit 10 taken along line I-I of FIG. 1. FIG. 3 is a plan view of an external shape of the sensor unit 10. FIG. 4 is a plan view of equipment 20A with the sensor unit in which the sensor unit 10 is assembled into the equipment 20.

In the following description, an XYZ rectangular coordinate system may be employed. The X direction is a longitudinal direction of a main body section 4 of a body 3 of the sensor unit 10. The Y direction is the direction orthogonal to the X direction in a plane along a mounting surface 4a of the main body section 4 and corresponds to the width direction of the main body section 4. The Z direction is the direction orthogonal to the X direction and the Y direction and corresponds to the thickness direction of the main body section 4. The plan view is a view as seen from the thickness direction (Z direction) of the main body section 4.

In FIG. 3, one direction (right direction) of the X direction is referred to as +X direction, and the opposite direction thereto is referred to as −X direction. One direction (upward direction) of the Y direction is referred to as +Y direction, and the opposite direction thereto is referred to as −Y direction.

As shown in FIGS. 1 and 2, the sensor unit 10 has a sensor element 1, a coupler 2 and the body 3. As shown in FIG. 2, the body 3 has the main body section 4 formed substantially in the shape of a plate, and an insertion section 5 provided on one surface 4a (mounting surface 4a) of the main body section 4. As shown in FIG. 1, the main body section 4 has a main part 6 and an external appearance identification part 7 which projects from the main part 6 in a plan view. As shown in FIG. 2, the mounting surface 4a is a surface which faces an external surface 21a of a casing 21 of the equipment 20. The mounting surface 4a of the main body section 4 abuts on the external surface 21a of the casing 21.

As shown in FIG. 3, the main part 6, in a plan view, has a first end portion 11 of a curved convex shape, an extension portion 12 which extends in the longitudinal direction (the X direction) from the first end portion 11, and a second end portion 13 of a curved convex shape formed in a tip of the extension portion 12.

The first end portion 11 is formed in the shape of a curved convex projecting in the direction (the −X direction) away from the extension portion 12 and has an outer edge 11a in the shape of a circular arc, for example. The extension portion 12 has a pair of lateral edges 12a, 12b of a straight line shape and becomes gradually narrower in width in the extending direction (the +X direction). The lateral edges 12a, 12b approach each other from one ends 12a1, 12b1 to the other ends 12a2, 12b2. Each of the lateral edges 12a, 12b extends in the tangential direction of the outer edge 11a of a circular arc shape from one end 11a1 and the other end 11a 2 of the outer edge 11a.

The second end portion 13 is formed in a curved convex shape projecting in the direction (the +X direction) away from the extension portion 12 and has an outer edge 13a of a circular arc shape connecting the other ends 12a2, 12b2 of the lateral edges 12a, 12b of the extension portion 12, for example. The tangential directions extending from one end 13a1 and the other end 13a2 of the outer edge 13a correspond to the directions of the lateral edges 12a, 12b. A contour line 6a of the main part 6 is configured by the outer edge 11a of the first end portion 11, the lateral edges 12a, 12b of the extension portion 12 and the outer edge 13a of the second end portion 13. The shapes of the outer edges 11a, 13a of the first end portion 11 and the second end portion 13 are not limited to the circular arc shape but may be an elliptic shape, a parabolic shape and the like.

Letting a center line 14 be a line connecting a center 11b of the circular arc-shaped outer edge 11a of the first end portion 11 and a center 13b of the circular arc-shaped outer edge 13a of the second end portion 13, the lateral edges 12a, 12b are located in line-symmetric positions with respect to the center line 14.

The external appearance identification part 7 has a first projecting portion 8 and a second projecting portion 9. The projecting portions 8, 9 each are configured to project from the lateral edges 12a, 12b of the main part 6 in a plan view (namely, when viewed from the direction perpendicular to the mounting surface 4a). The first projecting portion 8 is configured to project from the lateral edge 12a of the main part 6 in the direction perpendicular to the lateral edge 12a and away from the main part 6. The projecting direction of the first projecting portion 8 contains components in the +Y direction and the +X direction. The first projecting portion 8 has an outer edge 8a of a circular arc shape, for example. The second projecting portion 9 is configured to project from the lateral edge 12b of the main part 6 in the direction perpendicular to the lateral edge 12b and away from the main part 6. The projecting direction of the second projecting portion 9 contains components in the −Y direction and the +X direction. The second projecting portion 9 has an outer edge 9a of a circular arc shape, for example.

The projecting portions 8, 9 are formed in the shape of a plate along the mounting surface 4a (namely, along an XY plane). The projecting portions 8, 9 make it possible to distinguish the sensor unit 10 from another sensor unit based on the shape, in the determination of correctness of the sensor unit by the visual inspection and the comparison of shape data to be referred to later.

The first projecting portion 8 is formed in a middle portion 12c between the one end 12a1 and the other end 12a2 without being formed over the whole length of the lateral edge 12a. One end side portion 12e1 and the other end side portion 12f1 other than the middle portion 12c of the lateral edge 12a each are formed in a straight line shape and located on these respective extension lines. The lateral edge 12a has a straight line shape composed of the one end side portion 12e1, the other end side portion 12f1 and an extension line 12g1 between the one end side portion and the other end side portion.

The second projecting portion 9 is formed in a middle portion 12d between the one end 12b1 and the other end 12b2 without being formed over the whole length of the lateral edge 12b. One end side portion 12e2 and the other end side portion 12f2 other than the middle portion 12d of the lateral edge 12b each are formed in a straight line shape and located on these respective extension lines. The lateral edge 12b has a straight line shape composed of the one end side portion 12e2, the other end side portion 12f2 and an extension line 12g2 between the one end side portion and the other end side portion. Herein, the shapes of the outer edges 8a, 9a of the projecting portions 8, 9 are not limited in particular but may be a curved convex shape such as a circular arc shape, an elliptic shape, a parabolic shape or the like, a polygonal shape such as a rectangular shape, an inverted V-shape or the like, an indeterminate shape, etc.

The sensor unit 10 has a contour line 10a, in a plan view. The contour line 10a is composed of the outer edge 11a (circular arc shape) of the first end portion 11 of the main part 6, the one end side portion 12e1 (straight line shape) of the lateral edge 12a, the outer edge 8a (circular arc shape) of the first projecting portion 8, the other end side portion 12f1 (straight line shape) of the lateral edge 12a, the outer edge 13a (circular arc shape) of the second end portion 13, the other end side portion 12f2 (straight line shape) of the lateral edge 12b, the outer edge 9a (circular arc shape) of the second projecting portion 9 and the one end side portion 12e2 (straight line shape) of the lateral edge 12b.

As shown in FIGS. 1 and 2, in the main body section 4 there is formed a through hole 15 through which a fixture 31 is inserted. The through hole 15 is configured to pass through the main body section 4 in the thickness direction from the mounting surface 4a of the main body section 4 to an outer surface 4b (an opposite surface from the mounting surface 4a). A shape of the through hole 15 in a plan view is a circular shape, for example. The through hole 15 may be formed in an area including the second end portion 13 of the main body part 6 in a plan view.

The fixture 31 has a head portion 32 and a screw shaft portion 33 extending from the head portion 32. The screw shaft portion 33 of the fixture 31 is inserted into the through hole 15 and screwed into a fixing hole 24 formed in the casing 21 of the equipment 20. An outer diameter of the head portion 32 is larger than an inner diameter of the through hole 15. The main body section 4 is fixedly secured to the casing 21 by the fixture 31.

As shown in FIG. 2, the insertion section 5 is formed in the mounting surface 4a of the main body section 4. The insertion section 5 is configured to project in the direction (the downward direction of FIG. 2) perpendicular to the mounting surface 4a and away from the main body section 4. The insertion section 5 can be inserted into a mounting hole 22 which is formed in the casing 21 of the equipment 20. A shape in a plan view of the insertion section 5 is not limited in particular but maybe a circular shape, a rectangular shape and the like, for example.

On an outer peripheral surface of the insertion section 5 there is formed an annular recess 17 along the circumferential direction of the insertion section 5 in order for fitting an O-ring 16 thereto. The O-ring 16 fitted to the annular recess 17 contacts an inner surface of the mounting hole 22 and an outer surface (a surface within the annular recess 17 in detail) of the insertion section over the whole circumference whereby to be able to seal fluid-tightly a clearance between the inner surface of the mounting hole 22 and the outer surface of the insertion section 5.

The sensor element 1 is an element for detecting a temperature of oil (apart to be detected) such as an ATF, etc. and is a thermistor formed of a temperature sensitive resistor element, for example. The thermistor changes an electric resistor in response to the change of an oil temperature. The sensor element 1 is provided in an area including a tip surface 5a of the insertion section 5 and faces into an internal space 23 of the casing 21. Therefore, the sensor element 1 can detect the oil temperature of the internal space 23.

The coupler 2 is provided on the outer surface 4b of the main body section 4. The coupler 2 has an annular wall portion 18 and a plurality of terminals 19. The annular wall portion 18 is configured to project in the direction (the upward direction of FIG. 2) perpendicular to the outer surface 4b and away from the main body section 4. The plurality of terminals 19 are provided on the outer surface 4b on the inside of the annular wall portion 18. The coupler 2 is formed in an area including the first end portion 11, in a plan view. At least one of the plurality of terminals 19 is electrically connected to the sensor element 1 so as to be able to output a signal obtained from the sensor element 1. The body 3 and the annular wall portion 18 of the coupler 2 can be formed integrally by resin molding.

[Equipment with Sensor Unit]

As shown in FIG. 4, the equipment 20 into which the sensor unit 10 is assembled is a transmission to be used for the vehicle such as a motorcar and the like, for example. The internal space 23 of the casing 21 of the equipment 20 is sealingly filled with oil (fluid) such as an ATF (Automatic Transmission Fluid) and the like for smoothening speed change operation, etc.

The equipment 20 has an assembling part 25 formed of a part of the outer surface 21a of the casing 21. The sensor unit 10 is assembled in the assembling part 25. In the vicinity of the assembling part 25 there may be provided a protrusion 26 which projects in the height direction (the Z direction) with respect to the assembling part 25.

A sensor unit (for example, a sensor unit 40 as shown in FIG. 5) provided with another sensor element which is different from the sensor element 1 may be assembled in the assembling part 25, instead of the sensor unit 10. The equipment 20 into which the sensor unit 10 is assembled is referred to as equipment 20A with a sensor unit. Herein, the equipment into which the sensor unit is assembled is not limited to the transmission but may be an engine, an electric motor and the like to be used for the motorcar, etc.

### [Assembling Method of Sensor Unit]

Hereinafter, an assembling method of the sensor unit (a manufacturing method of the equipment with the sensor unit) according to the embodiment of the present invention will be described. FIG. 5 is a plan view of a sensor unit 40 as an example of another sensor unit. Herein, in the following description, the configuration corresponding to the sensor unit 10 is given like reference characters, and the description may be omitted. The sensor unit 40 has a similar configuration to the sensor unit 10 of FIG. 1, except that another sensor element is provided instead of the sensor element 1 and the external appearance identification part 7 is not provided.

The sensor unit 40 is provided with another sensor element (not shown), a coupler 2, and a body 43. Another sensor element is different in characteristics from the sensor unit 10 of FIG. 1. The body 43 has a main body section 44 formed substantially in a plate shape and the insertion section 5 (see FIG. 2) provided on one surface (mounting surface) of the main body section 44. The main body section 44 has a main part 6. The main body section 44 has a similar configuration to the main body section 4 of the sensor unit 10 of FIG. 1, except that the external appearance identification part 7 is not provided. The sensor unit 40, in a plan view, has a contour line 40a composed of an outer edge 11a (circular arc shape) of a first end portion 11 of the main part 6, a lateral edge 12a (straight line shape), an outer edge 13a (circular arc shape) of a second end portion 13 and a lateral edge 12b (straight line shape).

The sensor unit 40, as with the sensor unit 10, can be assembled into the assembling part 25 of the casing 21 in a posture in which a mounting surface of the main body section 44 faces the outer surface 21a of the casing 21 (see FIG. 2). The insertion section 5 of the sensor unit 40 is inserted into the mounting hole 22. Another sensor element is provided in an area including the tip surface 5a of the insertion section 5 thereby to face into the internal space 23 of the casing 21.

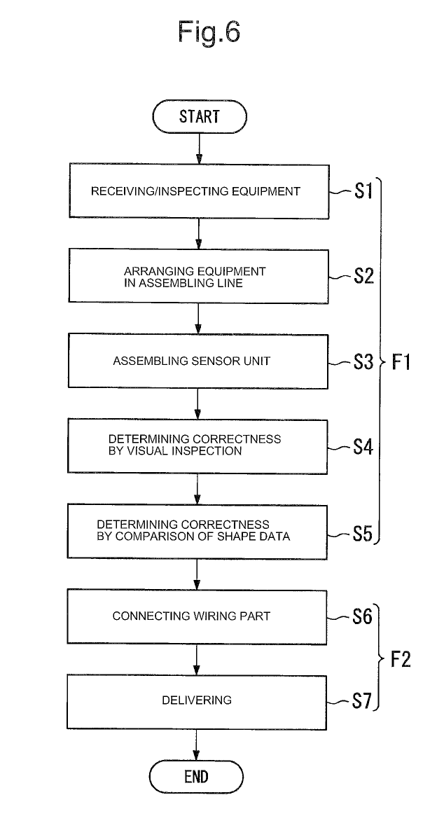

FIG. 6 is a flow chart of an assembling method of the sensor unit in accordance with this embodiment. As shown in FIG. 6, steps 1 to 5 are performed in a first plant F1 (first production facilities), for example. Steps 6 and 7 are performed in a second plant F2 (second production facilities) which is different from the first plant F1, for example. The first plant F1 and the second plant F2 may be located in different regions from each other.

### (Step 1: Arrangement of Equipment in an Assembling Line)

In the first plant F1, after receiving and inspecting the equipment 20 (Step S1), the equipment 20 is arranged in a predetermined assembling line (Step S2).

### (Step 2: Assembling of the Sensor Unit)

Next, as shown in FIGS. 2 and 4, the sensor unit 10 is assembled into the assembling part 25 of the casing 21 (Step S3 of FIG. 6). At that time, the sensor unit 10 is in the posture in which the mounting surface 4a of the main body section 4 faces the outer surface 21a of the casing 21. Thus, the equipment 20A with the sensor unit is obtained.

The insertion section 5 is inserted into the mounting hole 22. The O-ring 16 provided on the outer surface of the insertion section 5 seals fluid-tightly the clearance between the inner surface of the mounting hole 22 and the outer surface of the insertion section 5. The sensor element 1 is arranged in the area including the tip surface 5a of the insertion section 5 thereby to face into the internal space 23 of the casing 21.

### (Step 3: Correctness Determination by Visual Inspection)

The operator recognizes the external appearance of the sensor unit assembled into the equipment 20 by the visual inspection, and determines whether or not the sensor unit is the correct sensor unit to be assembled into the equipment 20, by visual inspection (Step S4 of FIG. 6). In this embodiment, the correct sensor unit is the sensor unit 10 of FIG. 1.

For example, when it is recognized by the visual inspection that the sensor unit assembled into the equipment 20 has the external appearance identification part 7 (the projecting portions 8, 9) (see FIG. 1), it can be determined that the assembled sensor unit is not the sensor unit 40 (see FIG. 5) but the sensor unit 10 (see FIG. 1).

When it is recognized by the visual inspection that the sensor unit assembled into the equipment 20 has no external appearance identification part 7 (projecting portions 8, 9), it can be determined that the assembled sensor unit is not the sensor unit 10 (see FIG. 1). Like this, the determination of the correctness of the sensor unit can be performed based on the existence or nonexistence of the external appearance identification part 7 by visually inspecting the sensor unit.

In the case where it has been determined that the sensor unit assembled into the equipment 20 is the sensor unit 10, the operator judges it to be “normal”. In the case where it has been determined that the sensor unit assembled into the equipment 20 is not the sensor unit 10, the operator judges it to be “error”.

### (Step 4: Correctness Determination by Comparison of Shape Data)

As shown in FIG. 6, in this step, the shape data of the sensor unit assembled into the equipment 20 is obtained, and the correctness determination of the sensor unit is performed by comparing the shape data with the reference shape data (Step S5). Hereunder, this step will be described in detail.

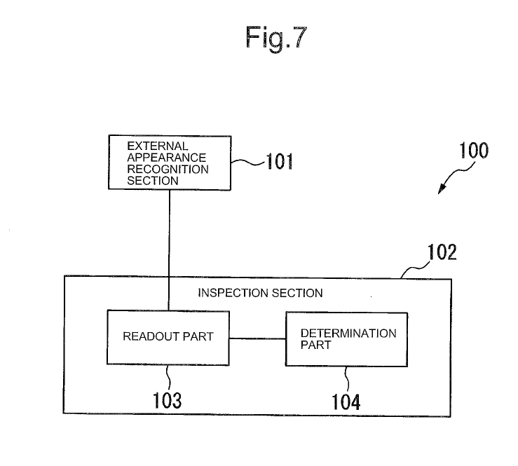

FIG. 7 is a block diagram showing an example of a correctness determination device to be usable in the present step. The correctness determination device 100 has an external appearance recognition section 101 and an inspection section 102. As the external appearance recognition section 101, a shape inspection device provided with a light emitting element (a laser light source and the like) and a light receiving element may be employed, for example.

Light from the light receiving element is irradiated to the sensor unit assembled into the equipment 20, and reflected light thereof is received by the light receiving element. Based on a light receiving position on the light receiving element, distance information to an object (the sensor unit) to be detected is obtained for each area of the detected object by a triangulation method, for example. The information (hereinafter, referred to as shape data) as to the shape (for example, the shape in a plan view, the shape in cross section or the like) of the detected object (the sensor unit) is extracted from this distance information. Thus, the shape data of the sensor unit assembled into the equipment 20 is provided.

The detection section 102 has a readout part 103 and a determination part 104. In the readout part 103 there is obtained a data designating a specification of the sensor unit 10. The data designating the specification is provided by QR codes (registered trademark), etc. in the specifications (not shown), etc., for example. In this embodiment, the data designating the specification is a data (referred to as a reference shape data) in relation to the external appearance of the sensor unit 10. The reference shape data includes the information as to the shape (for example, the shape in a plan view, the shape in cross section and the like) of the sensor unit 10.

In the determination part 104, the shape data of the sensor unit obtained in the external appearance recognition section 101 is compared with the reference shape data of the sensor unit 10. The determination part 104 determines the correctness of the sensor unit based on the existence or nonexistence of the external appearance identification part 7.

In other words, in the case where the external appearance identification part 7 is included in the shape data of the sensor unit obtained in the external appearance recognition section 101, the determination part 104 judges it to be “normal” and outputs a determination signal. To have obtained the determination of “normal” may be displayed on a display part (not shown). In the case where the external appearance identification part 7 is not included in the shape data of the sensor unit obtained in the external appearance recognition section 101, the determination part 104 judges it to be “error” and outputs a determination signal. To have obtained the determination of “error” may be displayed on a display part (not shown).

(Step 5: Removal of Equipment from Assembling Line)

In the case where the sensor unit of the equipment with the sensor unit is judged to be normal in each of the step 3 and the step 4, the equipment with the sensor unit is considered as a normal product and removed from the assembling line. In the case where the sensor unit of the equipment with the sensor unit is judged to be error in either the step 3 or the step 4, the equipment with the sensor unit is considered as an error product and removed from the assembling line.

### (Step 6: Connection of Wiring Part to Sensor Unit)

The equipment 20A with sensor unit judged normal is transferred to the second plant F2. In the second plant F2, the wiring part (not shown) is connected to the coupler 2 of the sensor unit 10 of the equipment 20A with sensor (Step S6 of FIG. 6).

### (Step 7: Delivery)

The equipment 20A with the sensor unit, in which the wiring part is connected to the coupler 2 is delivered to a post step (Step S7).

The sensor unit 10 is provided with the external appearance identification part 7 capable of distinguishing the sensor unit from another sensor unit (for example, the sensor unit 40 of FIG. 5), so that the determination of correctness (Steps 3, 4) can be performed by the visual inspection and the comparison of the shape data with respect to the sensor unit before the process (Step 6) of connecting the wiring part to the sensor unit. Therefore, the incorrect assembling can be detected early and accurately by the two steps determination.

The external appearance identification part 7 makes it possible to distinguish the sensor unit 10 from another sensor unit on the basis of the shape, so that the accuracy of the determination of correctness can be heightened, and the cost required for the determination can be reduced.

In comparison with the above, in the case of distinguishing between the correct sensor unit and another sensor unit on the basis of the color of the sensor unit, the distinguishing of the color may become difficult due to an environment to perform the determination, a capacity of the operator and the like thereby to decrease the accuracy of the determination of the correctness. In addition, the cost of a coloring agent may increase depending on an adopted color.

Since the external appearance identification part 7 has the projecting portions 8, 9 which project from the main body section 4 in a plan view, the projecting portions 8, 9 can be easily recognized when the operator inspects the body 3 and assembles the body 3 into the equipment from the direction perpendicular to the mounting surface 4a. Therefore, it is possible to improve the accuracy in determination of the correctness of the sensor unit (Steps 3, 4).

Since the projecting portions 8, 9 project in different directions from each other, so that, even if the operator inspects the sensor unit 10 from the position in which the first projecting portion 8 is hard to be inspected, the second projecting portion 9 is easy to be recognized. Therefore, it is possible to improve the accuracy in determination of the correctness of the sensor unit (Steps 3, 4).

Since the plurality of sensor units 10, 40 may be assembled into the equipment 20, there are advantages that common usage can be realized, and the like.

The equipment 20A with sensor unit has the sensor unit 10, so that, even if it is possible to assemble another sensor unit 40 into the equipment 20, the determination of correctness (Steps 3, 4) can be performed by the visual inspection and the comparison of the shape data with respect to the sensor unit before the process (Step 6) of connecting the wiring part to the sensor unit. Therefore, the incorrect assembling can be detected early and accurately.

According to the sensor unit assembling method of the embodiment, since the determination of correctness (Steps 3, 4) is performed by the visual inspection and the comparison of the shape data, the incorrect assembling can be detected early and accurately.

In the case where the step 6 of connecting the wiring part is performed in the second plant F2 which is different from the first plant F1 in which the step 2 is performed, when the incorrect assembling of the sensor unit is recognized at the time of connecting the wiring part in the second plant F2, the equipment 20 has to be returned from the second plant F2 to the first plant F1 whereby the production efficiency is deteriorated. Particularly, when the first plant F1 and the second plant F2 are located in the different areas, it takes a lot of time to return the equipment 20 whereby the deterioration of the production efficiency increases.

In comparison with this, according to the sensor unit assembling method of the embodiment, since the incorrect assembling can be inspected in the first plant F1, the equipment 20 is not required to be returned, so that the deterioration of the production efficiency can be avoided.

It is to be understood that the technical scope of the present invention is not limited to the above described embodiments but may include various changes and modifications of each of the above described embodiments without departing from the spirit and scope of the invention. In other words, the configuration and the like as described in the above embodiments are only an example, and various changes and modifications may be made properly.

For example, although the external appearance identification part 7 of the sensor unit 10 as shown in FIG. 1 has two projecting portions 8, 9, the number of the projecting portions may be one and an arbitrary number of more than three. Although the two projecting portions 8, 9 of the sensor unit 10 as shown in FIG. 1 project in the different directions from each other, the projecting directions of the plural projecting portions may be the same direction.

The external appearance identification part 7 of the sensor unit 10 as shown in FIG. 1 has projecting portions 8, 9. However, it is sufficient that the external appearance identification part is configured so as to distinguish the sensor unit from another sensor unit. Therefore, it is not limited to the projecting portion (projection) but may be such a configuration that the distinguishing from another sensor unit is performed by a difference in shape (for example, difference in shape in a plan view), such as a recess, an opening and the like formed in the body, for example.

The external appearance recognition section 101 of the correctness determination device 100 used in the step 4 (correctness determination by comparison of the shape data) may be an imaging device such as a CCD and the like. In the case of using the imaging device, the shape data of the sensor unit is obtained based on an image (for example, an image in a plan view) of the sensor unit. In the determination part 104, the shape data is compared with the reference shape data of the sensor unit 10. The determination part 104 can determine the existence or nonexistence of the external appearance identification part 7 by pattern matching and the like.

In the case where the external appearance identification part 7 is included in the shape data of the sensor unit obtained in the external appearance recognition section 101, the sensor unit is judged “normal”. In the case where the external appearance identification part 7 is not included in the shape data of the sensor unit obtained in the external appearance recognition section 101, the sensor unit is judged “error”.

In the above described embodiment, the sensor unit having a sensor element which detects the temperature of the oil such as an ATF and the like is illustrated as the sensor unit 10. However, the sensor unit is not limited to the temperature sensor, and it may be the sensor unit, etc. having the sensor element which detects a rotation rate of a turning part (a part to be detected), and the like, for example. In addition, without departing from the spirit of the present invention, it is possible to replace the component elements in the above described embodiment with the known component parts.

### DESCRIPTION OF REFERENCE CHARACTERS

1: Sensor element, 2: Coupler, 3: Body, 4: Main body section, 4a: Mounting surface, 7: External appearance identification part, 8: First projecting portion, 9: Second projecting portion, 10: Sensor unit, 20: Equipment, 20A: Equipment with sensor unit, 25: Assembling part, 40: Sensor unit (Another sensor unit)

A sensor unit (for example, a sensor unit 10 in an embodiment) according to a first embodiment includes a sensor element (for example, a sensor element 1 in the embodiment) , a coupler (for example, a coupler 2 in the embodiment) being connected to the sensor element, and a body (for example, a body 3 in the embodiment) configured to support the sensor element and the coupler and to be assembled from an outside into equipment which has a part to be detected, wherein the body has an external appearance identification part (for example, an external appearance identification part 7 in the embodiment) capable of distinguishing the sensor unit from other sensor unit which has other sensor element different from the sensor element.

According to a second embodiment, the body is provided with a main body section (for example a main body section 4 in the embodiment) which has a mounting surface (for example, a mounting surface 4a in the embodiment) facing the equipment, and the external appearance identification part has a projecting part (for example, projecting portions 8, 9) which projects from the main body section when viewed from the direction perpendicular to the mounting surface.

According to a third embodiment, the projecting part includes a first projecting portion (for example, a first projecting portion 8 in the embodiment) and a second projecting portion (for example, a second projecting portion 9 in the embodiment), the first projecting portion and the second projecting portion project in the different directions from each other with respect to the main body section.

According to a fourth embodiment, equipment with a sensor unit (for example, equipment 20A with a sensor in the embodiment) includes a sensor unit as defined in any one of embodiments 1 to 3, and equipment into which the sensor unit is assembled, wherein the equipment has an assembling part (for example, an assembling part 25 in the embodiment) into which the sensor unit is able to be assembled, the assembling part is configured such that other sensor unit instead of the sensor unit is able to be assembled into the assembling part.

According to a fifth embodiment, a sensor unit assembling method includes the steps in the sequence of installing equipment which has a part to be detected, in a predetermined assembling line, assembling the sensor unit as defined in any one of embodiments 1 to 3 into the equipment, determining the correctness of the sensor unit on the basis of existence or nonexistence of the external appearance identification part by visually inspecting the sensor unit, determining the correctness of the sensor unit on the basis of the existence or nonexistence of the external appearance identification part by obtaining shape data of the sensor unit which is assembled into the equipment and comparing this shape data with reference shape data, and removing the equipment from the assembling line.

According to a sixth embodiment the method further includes, connecting wiring to a coupler of the sensor unit which is assembled into the equipment, wherein the step of connecting the wiring is performed in a second plant (for example, a second plant F2 in the embodiment) which is different form a first plant (for example, a first plant F1 in the embodiment) in which the step of assembling the sensor unit into the equipment is performed.

According to the first embodiment, since the external appearance identification part capable of distinguishing the sensor unit from other sensor unit is provided, the determination of correctness can be performed by the visual inspection and the comparison of shape data with respect to the sensor unit before the process of connecting the wiring to the sensor unit. Therefore, the incorrect assembling can be detected early and accurately by two step determination.

According to the second embodiment, since the external appearance identification part has the projecting part which projects from the main body section when viewed from the direction perpendicular to the mounting surface of the body, the projecting part can be easily recognized when an operator inspects the body and assembles the body into the equipment from the direction perpendicular to the mounting surface, for example. Therefore, it is possible to improve the accuracy in determination of the correctness of the sensor unit.

According to the third embodiment, the first projecting portion and the second projecting portion project in the different directions from each other. Therefore, even if the operator inspects the sensor unit from a position in which the first projecting portion is hard to be inspected, the second projecting portion is easy to be recognized. Thus, it is possible to improve the accuracy in determination of the correctness of the sensor unit.

According to the fourth embodiment, since a plurality of sensor units can be assembled into the equipment, there are advantages that common usage, etc. can be realized, and the like. In the fourth embodiment, there is provided the sensor unit as defined in any one of the first to third features. Therefore, even if it is possible to assemble the other sensor unit into the equipment, the determination of correctness can be performed by the visual inspection and the comparison of shape data with respect to the sensor unit before the process of connecting the wiring to the sensor unit, so that the incorrect assembling can be detected early and accurately.

According to the fifth embodiment, since the determination of correctness is performed by the visual inspection and the comparison of the shape data, the incorrect assembling can be detected early and accurately.

In the case where the process of connecting the wiring is performed in the second plant which is different from the first plant in which the process of assembling the sensor unit into the equipment is performed, when the incorrect assembling of the sensor unit is recognized at the time of connecting the wiring in the second plant, the equipment has to be returned from the second plant to the first plant whereby the production efficiency is deteriorated. Particularly, when the first plant and the second plant are located in different areas, it takes a lot of time to return the equipment whereby the production efficiency is deteriorated large. In comparison with this, according to the sixth embodiment, since the incorrect assembling can be inspected in the first plant, the equipment is not required to be returned, so that the deterioration of the production efficiency can be avoided.

Obviously, numerous modifications and variations of the present invention are possible in light of the above teachings. It is therefore to be understood that within the scope of the appended claims, the invention may be practiced otherwise than as specifically described herein.

What is claimed is:

1. A sensor unit comprising:
a sensor element;
a coupler being connected to the sensor element; and
a body being configured to support the sensor element and the coupler and to be assembled from an outside into equipment which has a part to be detected;
wherein the body has an external appearance identification part capable of distinguishing the sensor unit from other sensor unit which has other sensor element different from the sensor element.

2. The sensor unit according to claim 1, wherein the body is provided with a main body section which has a mounting surface facing the equipment, and the external appearance identification part has a projecting part which projects from the main body section when viewed from the direction perpendicular to the mounting surface.

3. The sensor unit according to claim 2, wherein the projecting part includes a first projecting portion and a second projecting portion, the first projecting portion and the second projecting portion project indifferent directions from each other with respect to the main body section.

4. Equipment with a sensor unit comprising:
a sensor unit according to claim 1; and
equipment into which the sensor unit is assembled;
wherein the equipment has an assembling part into which the sensor unit is able to be assembled, and the assembling part is configured such that other sensor unit instead of the sensor unit is able to be assembled into the assembling part.

5. A sensor unit assembling method comprising the steps in the sequence of:
installing equipment which has a part to be detected, in a predetermined assembling line;
assembling the sensor unit according to claim 1 into the equipment;
determining the correctness of the sensor unit on the basis of existence or nonexistence of the external appearance identification part by visually inspecting the sensor unit;
determining the correctness of the sensor unit on the basis of the existence or nonexistence of the external appearance identification part by obtaining shape data of the sensor unit which is assembled into the equipment and comparing this shape data with reference shape data; and
removing the equipment from the assembling line.

6. The sensor unit assembling method according to claim 5, further comprising, connecting wiring to a coupler of the sensor unit which is assembled into the equipment, wherein the step of connecting the wiring is performed in a second plant which is different form a first plant in which the step of assembling the sensor unit into the equipment is performed.

7. A sensor unit comprising:
a sensor;
a coupler connected to the sensor, the sensor being to be connected to an outside of the sensor unit via the coupler; and
a body supporting the sensor and the coupler, the body being to be attached to an equipment from an outside of the equipment which includes an object to be detected by the sensor, the body comprising:
an external appearance to distinguish the sensor unit from an another sensor unit which has an another sensor different from the sensor.

8. The sensor unit according to claim 7, wherein the body is provided with a main body section which has a mounting surface facing the equipment, and the external appearance has a projecting part which projects from the main body section when viewed from a direction perpendicular to the mounting surface.

9. The sensor unit according to claim 8, wherein the projecting part includes a first projecting portion and a second projecting portion, the first projecting portion and the second projecting portion project indifferent directions from each other with respect to the main body section.

10. An apparatus comprising:
the sensor unit according to claim 7; and
an equipment to which the sensor unit is attached;
wherein the equipment has an assembling part into which the sensor unit is assembled, and the assembling part is configured such that an another sensor unit instead of the sensor unit is able to be assembled into the assembling part.

11. A sensor unit assembling method comprising:
assembling the sensor unit according to claim 7 into an equipment;
installing the equipment in a predetermined assembling line;
determining the correctness of the sensor unit based on existence or nonexistence of the external appearance by visually inspecting the sensor unit;
determining the correctness of the sensor unit based on the existence or nonexistence of the external appearance by obtaining shape data of the sensor unit which is assembled into the equipment and comparing the shape data with reference shape data; and
removing the equipment from the assembling line.

12. The sensor unit assembling method according to claim 11, further comprising, connecting wiring to a coupler of the sensor unit which is assembled into the equipment, wherein the step of connecting the wiring is performed in a second plant which is different form a first plant in which the step of assembling the sensor unit into the equipment is performed.
